(19) United States
(12) Patent Application Publication
(10) Pub. No.: US 2014/0041060 A1
(43) Pub. Date: Feb. 6, 2014

(54) Keypad Device

(71) Applicants: Andrew G. Selwood, Berkshire (GB); Scott Spiker, Phoenix, AZ (US)

(72) Inventors: Andrew G. Selwood, Berkshire (GB); Scott Spiker, Phoenix, AZ (US)

(73) Assignee: KEYMAT TECHNOLOGY LIMITED, Middlesex (GB)

(21) Appl. No.: 13/562,606

(22) Filed: Jul. 31, 2012

(51) Int. Cl. G06F 21/86

(52) U.S. Cl. CPC G06F 21/86
USPC 726/34

(57) ABSTRACT

An example tamper detection mechanism may include an electrical pathway having a closed conductive configuration and being openable to prevent electrical conduction along the electrical pathway, and may further include detection circuitry connected to the electrical pathway and configured to detect a change in the resistance of the electrical pathway. The electrical pathway includes a pair of conductive pads electrically isolated from one another, and also includes a connector which in the closed conductive configuration contacts both conductive pads to form an electrical connection therebetween. The connector is moveable away from the pads to open the electrical connection for tamper detection. The connector has a resistor of predefined resistance which in the closed conductive configuration is included in the electrical pathway. The detection circuitry can distinguish, on the basis of the resistance of the electrical pathway, between connection of the pads by the connector and shorting between the two pads.

### BACKGROUND OF THE INVENTION

The invention relates to a keypad device.

A known keypad device comprises a printed circuit board and a casing part. The casing part holds keys operable by a user to enter information. The printed circuit board is configured to generate electrical signals representative of the entered information. The keypad device includes a tamper detection mechanism. The tamper detection mechanism comprises an electrical pathway that has a closed conductive configuration and that can be opened so as to prevent electrical conduction along the electrical pathway. In addition, the tamper detection mechanism includes circuitry that is connected to the electrical pathway and that is configured to detect opening of the electrical pathway. The electrical pathway includes a pair of conductive pads electrically isolated from one another. The electrical pathway also includes a disc of conductive carbon material which contacts the two electrically conductive pads so as to form an electrical connection between the pads. If an attempt is made to disassemble the keypad device, this leads to separation of the carbon disc from the two electrically conductive pads. In turn, this breaks the electrical pathway and this is detected as a tamper event by the detection circuitry.

It is desirable to provide a keypad device having a greater degree of security compared to this known mechanism.

### BRIEF SUMMARY OF ASPECTS OF SOME EXAMPLE EMBODIMENTS

In accordance with a first aspect of the invention there is provided, a keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; wherein the connector comprises a resistor of predefined resistance which in said closed conductive configuration is included in the electrical pathway; and wherein the mechanism is such that the circuitry can distinguish, on the basis of the resistance of the electrical pathway, between said connection of said electrical contacts by the connector and shorting between the two electrical contacts.

In accordance with a second aspect of the invention there is provided, a keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; the connector comprising a resistor of predefined resistance which in said closed conductive configuration is included in the electrical pathway; wherein when the electrical pathway is in the closed conductive configuration the resistor contributes to the electrical pathway a predetermined percentage of the total resistance of the electrical pathway.

In accordance with a third aspect of the invention there is provided, a keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the contacts to open the electrical pathway for the detection of tampering; the connector comprising a resistor which in said closed conductive configuration is included in the electrical pathway; the resistor having a resistance of at least 1 k ohm.

### BRIEF DESCRIPTION OF THE DRAWINGS

The following is a more detailed description of embodiments of the invention, by way of example, reference being made to the appended schematic drawings in which:

FIG. 1 is an exploded view showing components of a type of keypad device referred to as a PIN entry device, the PIN entry device including a tamper detection mechanism;

FIG. 2 shows the front side of a printed circuit board of the PIN entry device of FIG. 1;

FIG. 3 shows the rear side of a moulded silicone mat of a prior art PIN entry device;

FIG. 4 is a perspective view of a spring loaded connector which forms part of the tamper detection mechanism incorporated into the PIN entry device of FIG. 1;

FIG. 5 is a cross-sectional view of the spring loaded connector of FIG. 4;

FIG. 6 is an exploded view showing how the spring loaded connector of FIGS. 4 and 5 is incorporated into the PIN entry device of FIG. 1;

FIG. 7 is a circuit diagram showing an electrical pathway which forms part of the tamper detection mechanism incorporated into the PIN entry device of FIG. 1;

FIG. 8 is a circuit diagram showing an alternative electrical pathway which forms part of a second tamper detection mechanism which may be incorporated into the PIN entry device of FIG. 1;

FIGS. 9 to 11 are perspective views of components of the second tamper detection mechanism; and

FIG. 12 shows a further alternative tamper detection mechanism.

### DETAILED DESCRIPTION OF EXAMPLE EMBODIMENTS

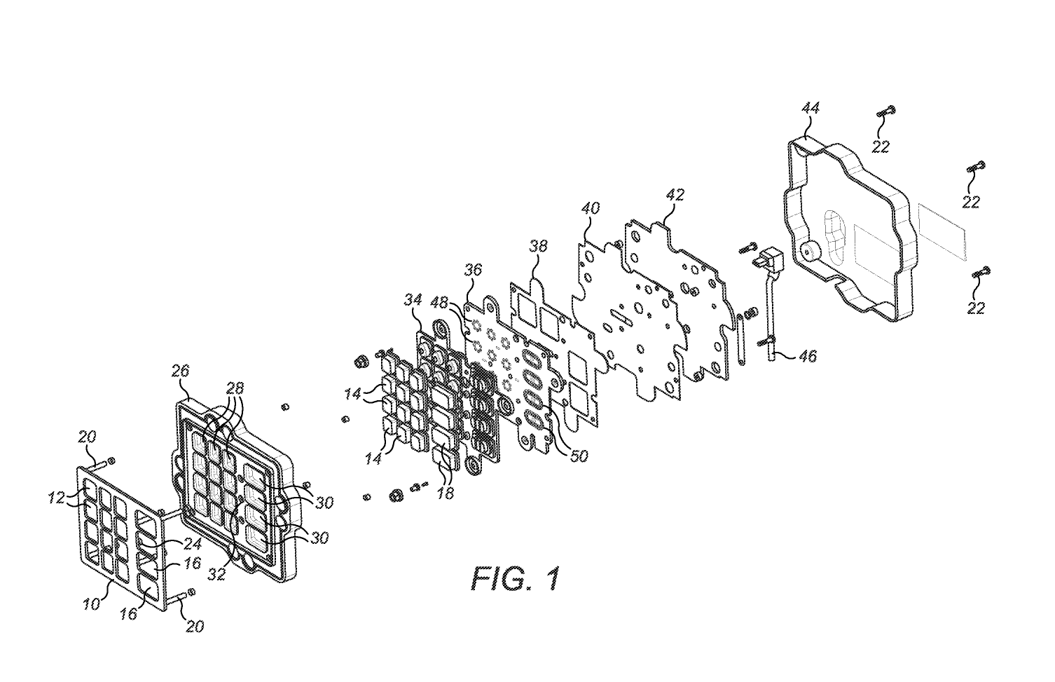

The components of a keypad device for entering a personal identification number (PIN) will now be described, starting from the left hand side of FIG. 1 and working to the right hand side of FIG. 1. This type of keypad device is commonly referred to as a PIN entry device and this term will be used in the following description, although it will be appreciated that the invention applies to other forms of keypad device. The left hand side of FIG. 1 corresponds to the front of the PIN entry device, as seen from the point of view of a user entering a PIN into the device. Hence, the right hand side of FIG. 1 corresponds to the rear of the PIN entry device. In the following description, the term “front” will be used in relation to parts of the PIN entry device which are either located at the left hand side of FIG. 1 or which face towards the left hand side. The term “rear” will be used in the following description in relation to parts of the PIN entry device which are either located at the right hand side of FIG. 1 or which face towards the right hand side of FIG. 1.

At the front side of the PIN entry device, there is a face plate 10 formed from a metal to provide structural strength. The face plate 10 has twelve square holes 12 through which, in the assembled PIN entry device, protrude twelve square key tops 14, which are also shown in FIG. 1. In addition, the face plate 10 is provided with four larger rectangular holes 16 through which, in the assembled PIN entry device, protrude four larger rectangular key tops 18. In use, the square and rectangular key tops 14, 18 are depressed by a user of the PIN entry device for PIN entry.

The face plate 10 also has four rearwardly projecting corner bosses 20, each of which is provided with an internal screw thread and which passes through the PIN entry device. The four corner bosses 20 engage with the screws 22 shown at the right hand side of FIG. 1 to hold the PIN entry device in its assembled configuration.

In addition, the face plate 10 has a rearwardly projecting, relatively short rod 24 which serves a purpose described below.

Immediately rearward of the face plate 10, there is a front casing half 26 formed of a tough moulded plastics material. The front casing half 26 has twelve square holes 28 through which protrude the twelve square key tops 14, and also four larger rectangular holes 30 through which protrude the four rectangular key tops 18. In addition, the front casing half 26 is provided with a hole 32 through which protrudes the short rod 24.

Immediately rearward of the key tops 14, 18, there is provided a moulded silicone mat 34. One function of the moulded silicone mat 34, in the assembled PIN entry device, is to provide a resilient force which urges the square key tops 14 and the rectangular key tops 18 in the forward direction. The moulded silicone mat 34 also serves other purposes which will be described in more detail below.

Immediately rearward of the moulded silicone mat 34 is the main printed circuit board 36 of the PIN entry device.

Immediately rearward of the main printed circuit board 36 are provided first and second insulating layers 38, 40. In the assembled PIN entry device, a metal plate (not shown) is provided between the first and second insulating layers 38, 40. The metal plate provides increased structural strength to the PIN entry device and prevents bending of the main printed circuit board 36 when the PIN entry device is struck. The metal plate carries an elastomeric connector (not shown), such as a Zebra™ connector, for connecting the main printed circuit board 36 to a secondary printed circuit board 42.

As shown in FIG. 1, the secondary printed circuit board 42 is located immediately rearward of the second insulating layer 40. The secondary printed circuit board 42 bears a battery (not shown) which serves to supply power to the main printed circuit board 36 at times when the PIN entry device is disconnected from its external power supply.

The rearmost component of the PIN entry device is the rear casing half 44 which engages with the front casing half 26 to enclose the components located therebetween.

As shown in FIG. 1, a USB cable 46 enters into the PIN entry device. The USB cable 46 connects to the rear side of the secondary printed circuit board 42 and serves to supply power from the external power source. The USB cable 46 also serves to carry encrypted signals from the PIN entry device.

In use, a user wishing to enter a PIN depresses the appropriate ones of the square key tops 14 and the rectangular key tops 18. The depression of each key top 14, 18 depresses an adjacent region of the moulded silicone mat 34 so that the adjacent region of the mat 34 moves into contact with the front surface of the main printed circuit board 36. The main printed circuit board 36 generates electrical signals which represent the numerals of the PIN entered by the user. The electrical signals are encrypted by the main printed circuit board 36 and carried by the USB cable 46 to other components, such as to a screen and/or to a card reading device.

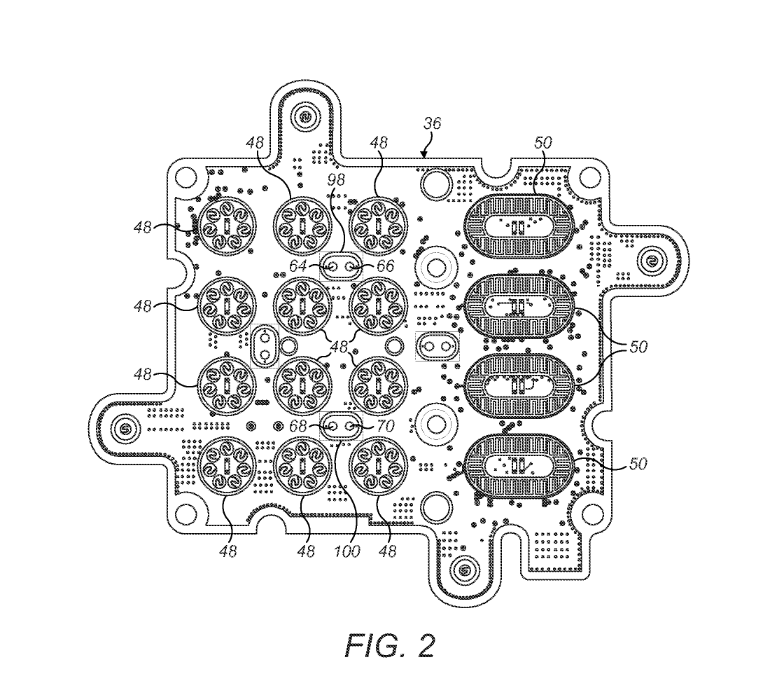

The front surface of the main printed circuit board 36 is shown in FIG. 2. As seen in this figure, the main printed circuit board 36 has twelve sets 48 of electrically conductive pads which correspond, respectively, to the twelve square key tops 14. In a known manner, each set 48 of electrically conductive pads cooperates with a corresponding set of electrically conductive carbon discs (not shown) located on the rear side of the moulded silicone mat 34. Hence, depression of one of the square key tops 14 moves a corresponding set of electrically conductive carbon discs into contact with a corresponding set 48 of electrically conductive pads on the front surface of the main printed circuit board 36.

Similarly, the front surface of the main printed circuit board 36 has four pairs 50 of electrically conductive pads, each of which operates in conjunction with a respective corresponding set of electrically conductive carbon discs (not shown) on the rear side of the moulded silicone mat 34. Each one of the four pairs 50 of electrically conductive pads, together with its corresponding set of conductive carbon discs, operates to generate an electrical signal when one of the larger rectangular key tops 18 is depressed.

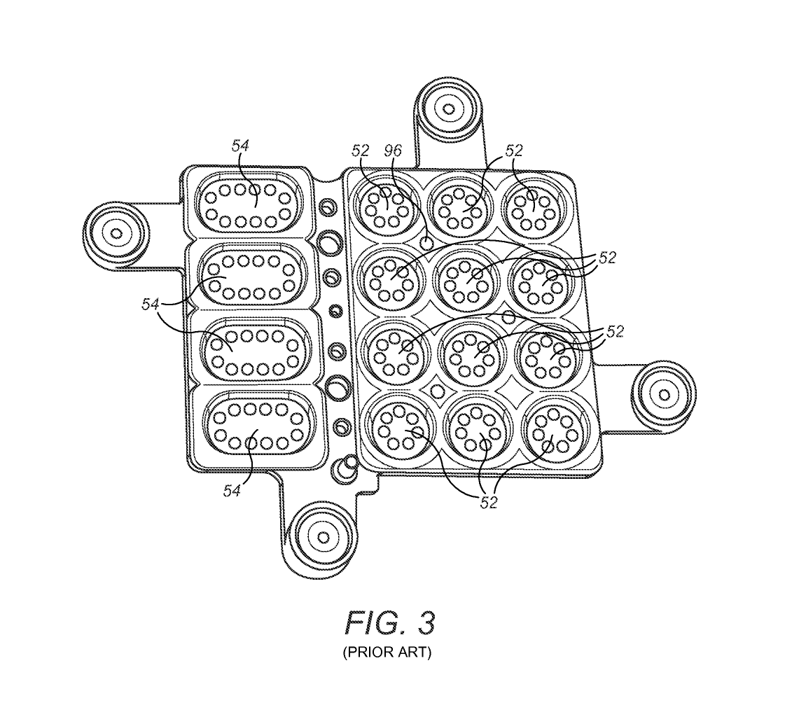

The rear side of a moulded silicone mat is shown in FIG. 3. However, it is emphasised that the moulded silicone mat shown in FIG. 3 is from a prior art PIN entry device and not from the PIN entry device shown in FIG. 1. The moulded silicone mat shown in FIG. 3 bears twelve sets 52 of carbon discs, each arranged in a circle, and four sets 54 of carbon discs each arranged in an oval. The sets 52, 54 of carbon discs shown in FIG. 3 are identical to the carbon discs located on the rear side of the moulded silicone mat 34 shown in FIG. 1.

It will be appreciated that it is very important to prevent unauthorised access to the main printed circuit board 36 so as to prevent thieves from obtaining sensitive information from the main printed circuit board 36. The PIN entry device is provided with several security mechanisms which are designed to prevent unauthorised access to the interior of the PIN entry device and, in particular, to the main printed circuit board 36. In many cases, the security mechanisms are designed to detect intrusion attempts and to trigger the deletion of sensitive information from the main printed circuit board 36 if an attempted intrusion is detected. The current invention relates to one of these security mechanisms and is intended to detect attempts to separate the front casing half 26 (and optionally also the face plate 10) from the main printed circuit board 36.

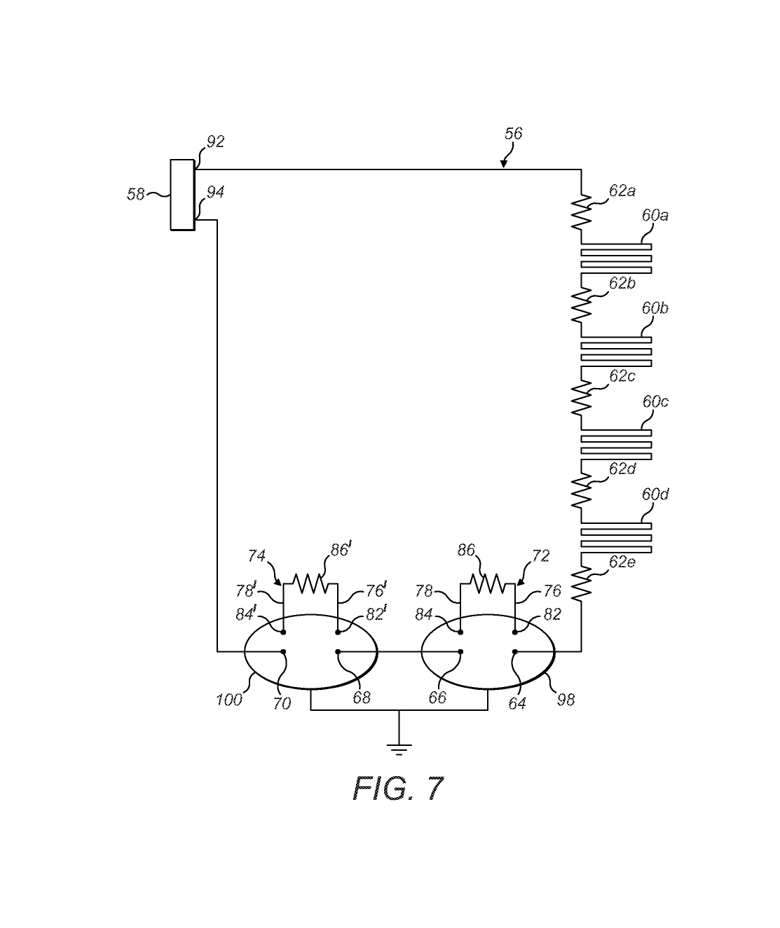

Referring to FIG. 7, the tamper detection mechanism of the PIN entry device comprises an electrical pathway 56 together with detection circuitry 58. The detection circuitry 58 is connected to the electrical pathway 56 and is capable of detecting opening of the electrical pathway 56 (that is to say an event in which the electrical pathway 56 is broken) and also a change in the total resistance of the electrical pathway 56.

As seen in FIG. 7, the electrical pathway 56 has four serpentine regions 60a, 60b, 60c, 60d. In practice, the four serpentine regions 60a, 60b, 60c, 60d are considerably more extensive than their pictorial representations in FIG. 7. When considered collectively, the four serpentine regions 60a, 60b, 60c and 6d cover large portions of the main printed circuit board 36 and of the secondary printed circuit board 42. The four serpentine regions 60a, 60b, 60c and 60d are not shown in FIGS. 1 and 2. As known in the art, each serpentine region 60a, 60b, 60c, 60d consists of a single linear electrically conductive track that is arranged in a highly serpentine manner so as to have many adjacent lengths. The arrangement is such that it is almost impossible to drill through either the main printed circuit board 36 or the secondary printed circuit board 42 without causing a break in at least one of the four serpentine regions 60a, 60b, 60c, 60d. Breaking of one of the serpentine regions would open the electrical pathway 56 and this would be detected by the circuitry 58.

The electrical pathway 56 also includes five fixed resistors 62a, 62b, 62c, 62d, 62e. These resistors 62a, 62b, 62c, 62d, 62e are referred to as “fixed” as they are fixedly incorporated into either the main printed circuit board 36 or the secondary printed circuit board 42. As shown in FIG. 7, the five fixed resistors 62a, 62b, 62c, 62d, 62e are interspersed with the serpentine regions 60a-60d. The purpose of the five fixed resistors 62a-62e is to allow detection of an attempt to bypass one or more of the four serpentine regions 60a-60d. Thus, an attempt to connect one point on the electrical pathway 56 to another point on the electrical pathway 56, so as to bypass one or more of the serpentine regions 60a to 60d, would generally also result in bypassing of at least one of the five fixed resistors 62a to 62e. In this way, such an attempt will reduce the overall resistance of the electrical pathway 56, and this will be detected by the circuitry 58.

None of the four serpentine regions 60a-60d, nor any of the five fixed resistors 62a-62e, are visible on the front surface of the main printed circuit board 36 (see FIG. 2). This is because those ones of the serpentine regions 60a-60d and those ones of the fixed resistors 62a-62e that are located on the main printed circuit board 36, as opposed to being located on the secondary circuit board 42, are either located on the rear surface or internally.

As shown in FIG. 7, the electrical pathway 56 includes a first pair of electrically conductive pads 64, 66 and a second pair of electrically conductive pads 68, 70. The electrically conductive pads 64, 66 of the first pair, and also the electrically conductive pads 68, 70 of the second pair are exposed at the front surface of the main printed circuit board 36 and can be seen in FIG. 2. As seen in both FIGS. 7 and 2, the electrically conductive pads 64, 66 of the first pair are electrically isolated from one another, and the electrically conductive pads 68, 70 of the second pair are also electrically isolated from one another.

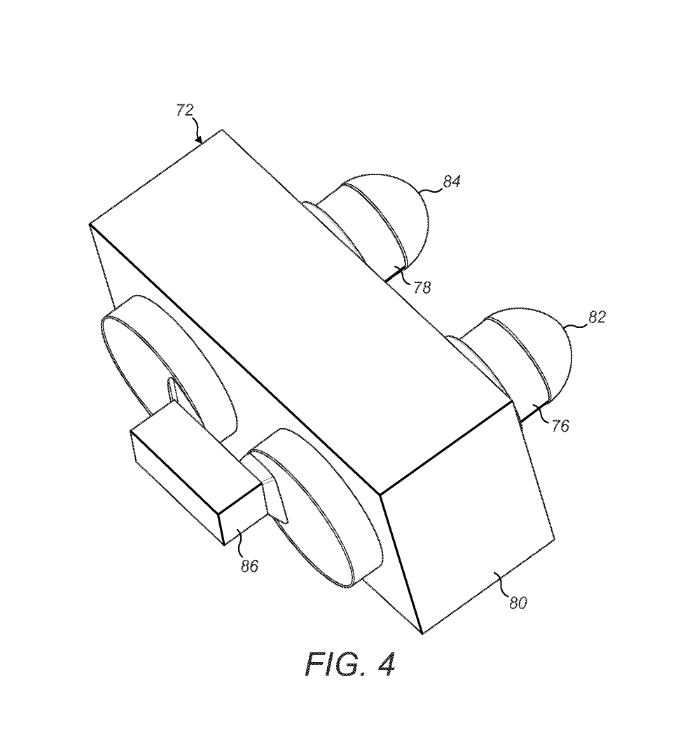

As shown in FIG. 7, the electrical pathway 56 also includes first and second connectors 72, 74. The first connector 72 is shown in FIGS. 4-6. The second connector 74 is identical to the first connector 72 and so only the first connector 72 will be described in detail. The component parts of the second connector 74 will be given the same reference numerals as the corresponding component parts of the first connector 72, with the reference numerals that relate to the second connector 74 being designated prime.

Referring to FIG. 4, the first connector 72 has two spring loaded pins 76, 78 which are embedded, parallel to one another, in a plastics block 80. Each pin 76, 78 has a respective tip 82, 84. The tips 82, 84 lie at the same side of the plastics block 80. On the opposite side of the plastics block 80, the two base ends of the spring loaded pins 76, 78 are electrically connected to one another by a resistor 86 which is soldered to each one of the pins 76, 78. The arrangement is such that each pin tip 82, 84 can be depressed (against the spring loading) towards the plastic block 80 along the axis of the corresponding spring-loaded pin 76, 78.

The connector 72 is relatively small and has dimensions in the order of a few millimetres. The resistor 86 is a commercially available 0603 resistor. The designation 0603 indicates that the dimensions of the resistor are 0.6 mm by 0.3 mm. The resistor 86 has a resistance of 10 k ohm.

Each spring loaded pin 76, 78 is electrically conductive, being made of metal. Hence, as seen in FIG. 7, in which the first connector 72 is shown diagrammatically as a circuit component, there is a continuous electrical pathway from one of the tips 82 along the associated spring loaded pin 76 through the resistor 86, back through the second spring loaded pin 78 to the tip 84 of the second spring loaded pin 78.

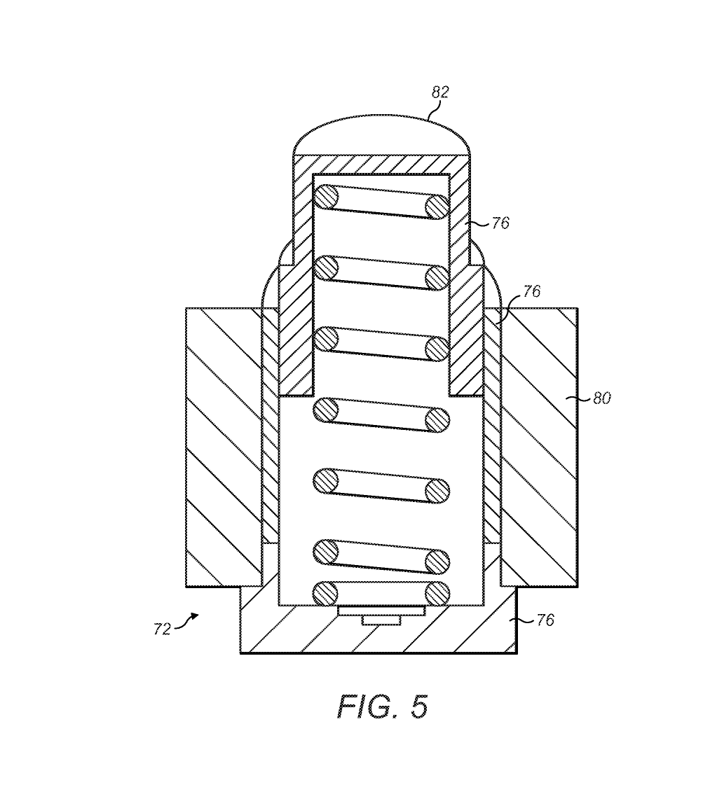

One of the spring loaded pins 76 is shown in cross section in FIG. 5.

A unit consisting of two spring loaded pins embedded in a plastics block, as shown in FIG. 4 (but without the resistor 86), is commercially available from Mil-Max Manufacturing Corporation under the part number 811-22001-30-00001-1.

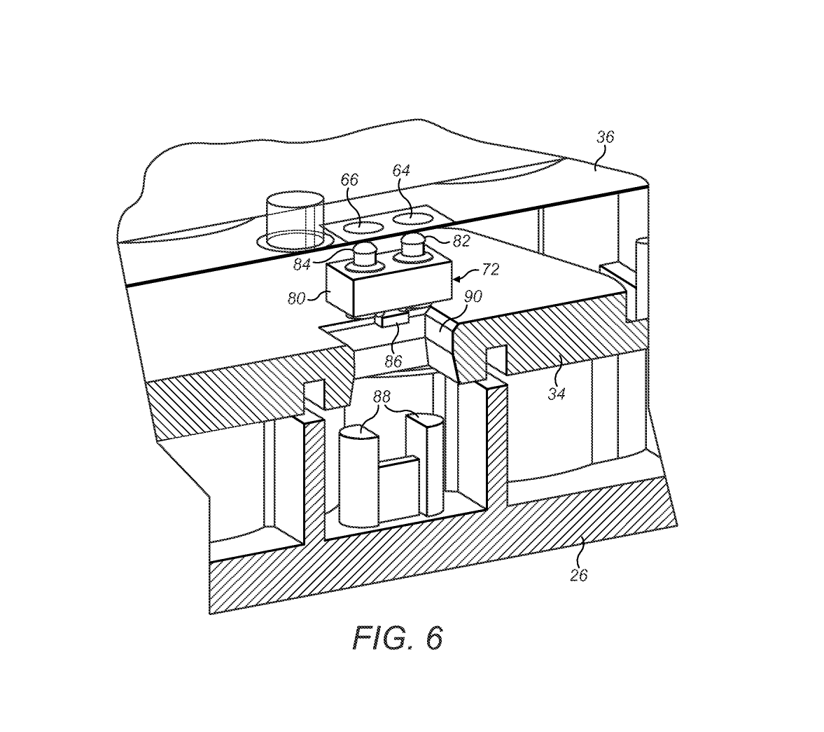

FIG. 6 shows how the first connector 72 is assembled in the PIN entry device of FIG. 1.

As shown in FIG. 6, the front casing half 26 has a pair of support pillars 88 which extend rearwardly. The moulded silicone mat 34 is provided with a rectangular cut out 90 which is dimensioned to receive the plastics block 80 of the connector 72 in a close fitting relationship. As seen in FIG. 6, the two tips 82, 84 of the first connector 72 are directed rearwardly towards the main printed circuit board 36. The base ends of the two spring loaded pins 76, 78 abut the two support pillars 88 on the front casing half 26.

When the first connector 72 is engaged in the rectangular cut out 90 of the moulded silicone mat 34, with the two support pillars 88 in contact with the first connector 72, the two tips 82, 84 of the spring loaded pins 76, 78 are directed towards and aligned with respective ones of the electrically conductive pads 64, 66 of the first pair of electrically conductive pads. FIG. 6 is an exploded view but when the PIN entry device is assembled, each one of the two spring loaded pins 76, 78 is compressed between a respective one of the two support pillars 88 and a respective one of the electrically conductive pads 64, 66 of the first pair. Hence, the tip 82 of the spring loaded pin 76 is partially depressed and forced by the internal spring loading against the electrically conductive pad 64. The tip 84 of the spring loaded pin 78 is partially depressed and forced by the internal spring loading against the conductive pad 66.

The spring loading provided by the internal springs (see FIG. 5) ensures that the tips 82, 84 of the spring loaded pins 76 78 are kept in contact with the electrically conductive pads 64, 66 despite acceptable manufacturing variations in the components of the PIN entry device and despite acceptable variations in the assembled configuration.

In FIG. 7, for clarity, the two pin tips, 82, 84 of the first connector 72 are spaced from the corresponding pair of electrically conductive pads 64, 66. However, as described above, when the PIN entry device is assembled, each one of the pin tips 82, 84 contacts, and is urged against, the corresponding one of the electrically conductive pads 64, 66 and so the first connector 72 forms an electrical connection between the first pair of electrically conductive pads 64, 66.

Likewise, when the PIN entry device is assembled, the second connector 74 forms an electrical connection between the electrically conductive pads 68, 70 of the second pair, with the pin tip 82′ of the second connector 74 contacting the conductive pad 68 and the pin tip 84′ of the second connector 74 contacting the electrically conductive pad 70. As for the first connector 72, there is also a complete electrical pathway passing through the second connector 74 from one of the pin tips 82′ through the resistor 86′ to the other pin tip 84′.

Hence, when the PIN entry device is assembled, the first and second connectors 72, 74 complete the electrically pathway 56 so as to allow the detection circuitry 58 to pass a current therethrough.

The detection circuitry 58 includes an output pin 92 and an input pin 94. The detection circuitry 58 generates a random signal which is applied to the electrical pathway 56 at the output pin 92. The detection circuitry analyses the return signal detected at the input pin 94, at the other end of the electrical pathway 56. The detection circuitry 58 performs two tests on the signal at the input pin 94. Firstly, in order to pass the tests, the return signal on the input pin 94 must match the random signal applied at the output pin 92. Secondly, the detection circuitry 58 utilises a voltage divider to ensure that there is no change in the resistance of the electrical pathway 56. The detection circuitry 58 is conventional in design.

If the electrical pathway 56 is broken, for example by drilling through a serpentine region 60a to 60d, then there will be no return signal at the input pin 94 or alternatively, if the electrical pathway 56 is shorted, so as to bypass one of the fixed resistors 62a to 62e, then the total resistance of the electrical pathway 56 as detected at the input pin 94 will change and this will also be detected.

The first and second connectors 72, 74 operate to detect any attempt to remove the front casing half 26. An attempt to remove the front casing half 26 will result in the front casing half 26 moving away from the main printed circuit board 36. In turn, this results in the tips 82, 82′, 84, 84′ of the first and second connectors 72, 74 moving away from the electrically conductive pads 64, 66, 68, 70 of the first and second pairs. This opens the electrical pathway 56 resulting in no return signal at the input pin 94 and this is detected by the detection circuitry 58.

As indicated above, the plastics block 80 of the first connector 72 fits closely within the rectangular cut-out 90 in the moulded silicone mat 34. The moulded silicone mat 34 is held relative to the front casing half 26. This helps to ensure that any relative movement between the front casing half 26 and the main printed circuit board 36 removes the connectors 72, 74 from the conductive pads 64,66,68,70 and opens the electrical pathway 56.

The spring loading of the spring loaded pins 76, 76′, 78, 78′ helps to ensure that very slight relative movement between the front casing half 26 and the main printed circuit board 36, for example such as may occur due to differential expansion during a change in ambient temperature, does not lead to a false tamper signal.

The tamper detection mechanism described above, including the connectors 72, 74 provides a very significant advantage over known tamper detection mechanisms that are intended to detect separation of a casing part from the printed circuit board.

In one such known system, a pair of electrically conductive pads is provided on a front surface of a main printed circuit board. The electrically conductive pads operate in conjunction with a disc of carbon attached to a rear side of a moulded silicone mat. The carbon disc forms an electrical connection between the pads when in contact with both. The moulded silicone mat shown in FIG. 3 is, in fact, part of a known PIN entry device incorporating such a known tamper detection mechanism. As seen at 96 in FIG. 3 a disc of conductive carbon material is attached to the rear face of the moulded silicone mat and this carbon disc 96 operates with the pair of conductive pads of the known tamper detection mechanism.

A potential problem with such a known arrangement is that a skilled thief may be able to drill a hole in the casing of the PIN entry device and inject an electrically conductive resin onto the front surface of the main printed circuit board, so that the electrically conductive resin forms a short between the two electrically conductive pads on the surface of the main printed circuit board. Once the resin has set, the casing part can be removed and the consequent removal of the conductive carbon disc 96 from the two electrically conductive pads does not trigger a tamper signal because the conductive pads are shorted together. A tamper signal in these circumstances is circumvented because the resistance of the carbon disc is substantially zero and the resistance of the electrically conductive resin is also substantially zero. Hence the replacement of the carbon disc by the electrically conductive resin does not significantly change the total resistance of the tamper circuit.

In the tamper detection mechanism of the current invention, the resistors 86, 86′ have a significant resistance—in the example given above each resistor 86, 86′ has a resistance of 10 k ohm. Hence, should a thief attempt to circumvent the tamper detection mechanism of the current invention, by injecting an electrically conductive resin to form a short between the two pads 64, 66 and also between the two pads 68, 70, then the total resistance of the electrical pathway 56 would be altered and this would be detected by the detection circuitry 58.

In order to attempt to defeat the tamper detection mechanism of the current invention, the thief might firstly attempt to ascertain the resistance of each resistor 86, 86′. (The resistors 86, 86′ could have different resistances from one another.) The thief may then attempt to replace each one of the connectors 72, 74 with a respective bridge of similar resistance to the connector so as to bridge the electrically conductive pads 64, 66 and also to bridge the electrically conductive pads 68, 70. These two actions may in themselves be impossible. Moreover, the thief would need to perform the two actions without causing any transient increase or decrease in the total resistance of the electrical pathway 56. Accordingly, it is very much more difficult, if not impossible, to circumvent the tamper detection mechanism described above, using the connectors 72, 74, compared to the known tamper detection mechanism which uses a disc of conductive carbon material to bridge two pads.

Moreover, if a thief attempted to replace one of the connectors 72, 74 with a bridge of similar resistance, he would in practice firstly have to place the bridge in contact with the two electrically conductive pads and then remove the connector 72, 74. This means that the bridge is first in parallel with the connector 72, 74 and then replaces the connector 72, 74. By carefully choosing the resistance of the resistors 86, 86′, the total resistance of the electrical pathway 56, and the detection thresholds of the detection circuitry 58, it is possible to ensure that a bridge of any resistance will be detected. More specifically, these parameters can be chosen so that if a bridge has a resistance sufficiently similar to that of the connector 72, 74 so as to fool the detection circuitry 58 when the bridge replaces the connector 72, 74, it will trigger a tamper signal by altering the total resistance of the electrical pathway 56 when in parallel with the connector 72, 74. Conversely, if the resistance of the bridge is such that it does not trigger a tamper signal when in parallel with the connector 72, 74, the resistance of the bridge will be such to trigger a tamper signal when the bridge replaces the connector 72, 74. In order to achieve this result, the detection thresholds of the detection circuitry 58 may first be decided. Then a relatively simple calculation using Ohm's law may be used to determine appropriate values for the resistances of the connectors 72, 74 and for the total resistance of the electrical pathway 56.

As shown in FIGS. 7 and 2, a first conductive track 98 of oval shape passes around the first pair of electrically conductive pads 64, 66 at the front surface of the main printed circuit board 36. Similarly, the second conductive track 100 of oval shape passes around the second pair of electrically conductive pads 68, 70 at the front surface of the main printed circuit board 36. Each one of these oval conductive tracks 98, 100 is connected to Earth. The first and second oval conductive tracks 98, 100 serve as a second tamper detection mechanism. Specifically, if a conductive resin or the like is injected into the region of the first pair of electrically conductive pads 64, 66, or into the region of the second pair of electrically conductive pads 68, 70, it is quite likely that the resin would form a short between at least one of the conductive pads and the adjacent oval conductive track 98, 100. This would connect the electrical pathway 56 to Earth (see FIG. 7), and this would be detected by the detection circuitry 58.

As described above, the face plate 10 carries a short rod 24 which passes rearwardly through the hole 32 in the front casing half 26. Although not shown in the drawings, the short rod 24 could be used, instead of the two support pillars 88, to urge a connector 72, 74, against a cooperating pair of electrically conductive pads. In this way, an attempt to remove the face plate 10 would lead to withdrawal of the short rod 24 and would allow the connector 72, 74, previously depressed by the short rod 24, to move away from its cooperating pair of conductive pads. This would enable detection of an attempt to remove the face plate 10, even if there is no attempt to remove the front casing half 26.

It will be appreciated that many changes may be made to the specific embodiment described above, without departing from the invention as defined in the claims.

For example, the electrical pathway 56 need not be as shown in FIG. 7. The electrical pathway 56 may contain any number of serpentine regions 60a-60d or, alternatively, no serpentine regions at all. Similarly, the fixed resistors 62a-62e are not essential to the current invention and can be dispensed with, or their number or arrangement may be altered.

It is not necessary to have two connectors 72, 74 as described above. It would be possible to have a single connector or any plural number of connectors.

It is not necessary for the detection circuitry 58 to produce a random signal as described above. Although less preferred, the detection circuitry 58 could simply produce a signal of constant voltage.

In the example given above, the resistors 86, 86′ each have a resistance of 10 k ohm. However, this is not essential. Any suitable resistance value may be used and the resistances of the two resistors 86, 86′ may be different from one another. Preferably, each resistor 86, 86′ (and so each connector 72, 74) has a resistance of at least 1 k ohm, more preferably at least 2 k ohm, and even more preferably at least 5 k ohm.

In the example given above, each connector 72, 74 (or each resistor 86, 86′), contributes about 14.3% of the total resistance of the electrical pathway 56. (This is because the resistance of each of the five fixed resistors 62a-62e is 10 k ohm and the resistance of each resistor 86, 86′ is also 10 k ohm.) However, this need not be the case. The resistance contributed to the total resistance of the electrical pathway 56 by each connector 72, 74 may be any suitable percentage of the total resistance. Preferably, this percentage will be at least 2%, more preferably at least 5%, and even more preferably at least 10%.

The mechanical construction of the PIN entry device need not be as shown in FIG. 1. Any suitable mechanical construction may be used.

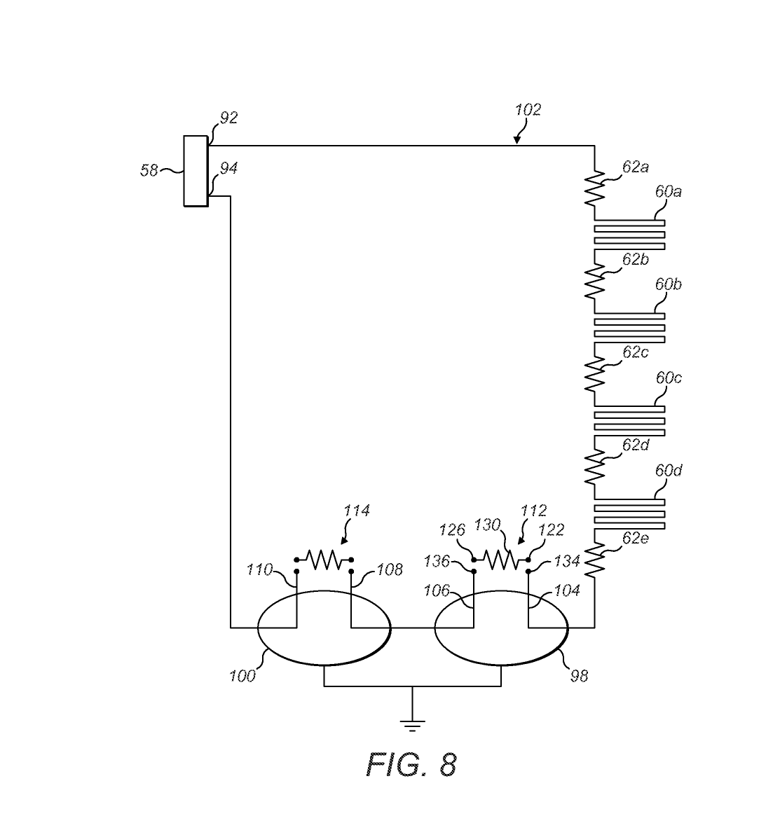

A second, alternative tamper detection mechanism is shown in FIGS. 8-11. In the following description, features of the second tamper detection mechanism which are identical to corresponding features of the first tamper detection mechanism described above with reference to FIGS. 1 to 7, will be given the same reference numerals and will not be described.

In the second tamper detection mechanism (see FIG. 8), spring-loaded pins are soldered into an electrical pathway 102 (which corresponds to the electrical pathway 56 of the first mechanism). Comparing FIGS. 7 and 8, in the second tamper detection mechanism, the pad 64 of the first mechanism is replaced by a first spring-loaded pin 104, the pad 66 of the first mechanism is replaced by a second spring-loaded pin 106, the pad 68 of the first mechanism is replaced by a third spring-loaded pin 108, and the pad 70 of the first mechanism is replaced by a fourth spring-loaded pin 110.

The first, second, third and fourth spring-loaded pins 104, 106, 108 and 110 may be soldered onto the front surface of the main printed circuit board 36 or they may pass through respective holes in the main printed circuit board for connection with the electrical pathway 102 either internally or at the rear face of the main printed circuit board 102.

The first, second, third and fourth spring-loaded pins 104, 106, 108 and 110 are electrically conductive.

The first and second spring-loaded pins 104, 106 form a first pair, and the third and fourth spring-loaded pins 108, 110 form a second pair.

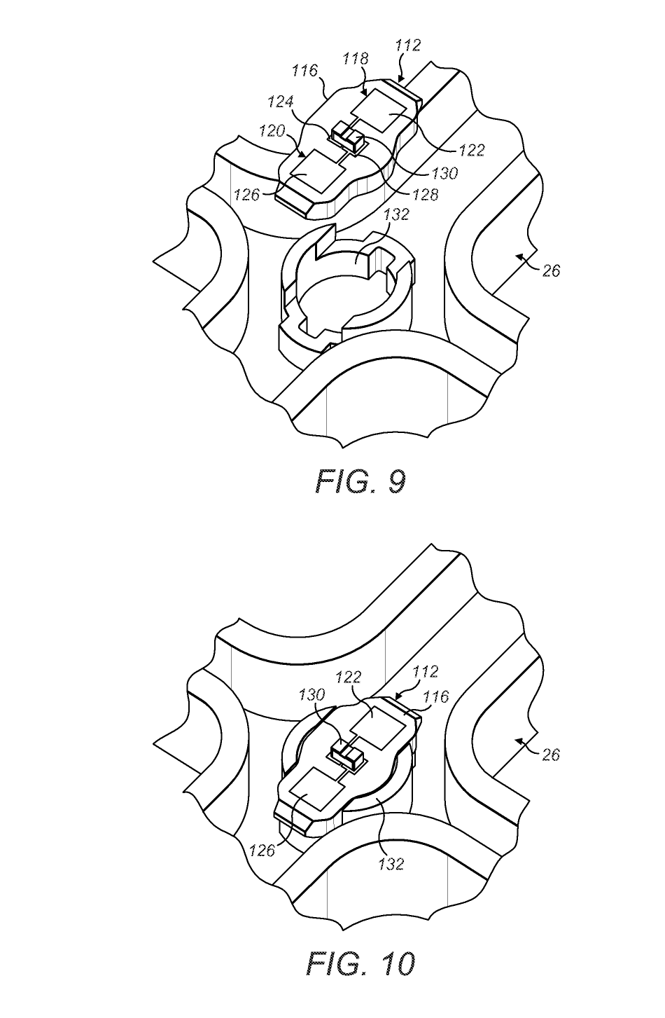

In the second tamper detection mechanism, the two connectors 72, 74 of the first mechanism are replaced by a first connector 112 and a second connector 114. The first connector 112 is shown in FIGS. 9, 10 and 11. The second connector 114 (shown schematically in FIG. 8) is identical to the first connector 112 and will not be described in detail.

Referring to FIG. 9, the first connector 112 is a simple, small printed circuit board 116. A surface of the circuit board 116 is provided with first and second conductive tracks 118, 120. The first conductive track 118 has a larger rectangular pad 122 connected to a smaller rectangular pad 124. Similarly, the second conductive track 120 has a larger rectangular pad 126 connected to a smaller rectangular pad 128. The two smaller rectangular pads 124, 128 are adjacent to one another, but electrically isolated from one another. A resistor 130 (in this case of 10 k ohm resistance) is soldered between the two smaller pads 124, 128 so as to complete an electrical pathway, including the resistor 130, between the two larger rectangular pads 122, 126.

As shown in FIGS. 9 and 10, the first connector 112 engages in a recess 132 on the rear face of the front casing half 26. The first connector 112 fits closely within the recess 132 and is retained by friction in the recess 132.

In normal operation, as illustrated in FIG. 11, a tip 134 of the first spring-loaded pin 104 contacts the larger rectangular pad 122 and a tip 136 of the second spring-loaded pin 106 contacts the larger rectangular pad 126. In this way the first connector 112 bridges, and forms an electrical connection between, the first and second spring-loaded pins 104, 106. Likewise the second connector 114 bridges, and forms an electrical connection between, the third and fourth spring-loaded pins 108, 110. Hence the first and second connectors 112, 114 complete the electrical pathway 102.

The moulded silicone mat 34 is omitted for clarity from FIG. 11. The spring-loaded pins 104, 106, 108, 110 pass through an aperture (not shown) in the silicone mat 34 as they extend towards the front casing half 26.

The spring-loaded pins 104, 106, 108, 110 are compressed against the first and second connectors 112, 114.

If an attempt is made to separate the front casing half 26 from the main printed circuit board 36, the two connectors 112, 114 will separate from the spring-loaded pins 104, 106, 108, 110 and this will open the electrical pathway 102 and cause a tamper signal.

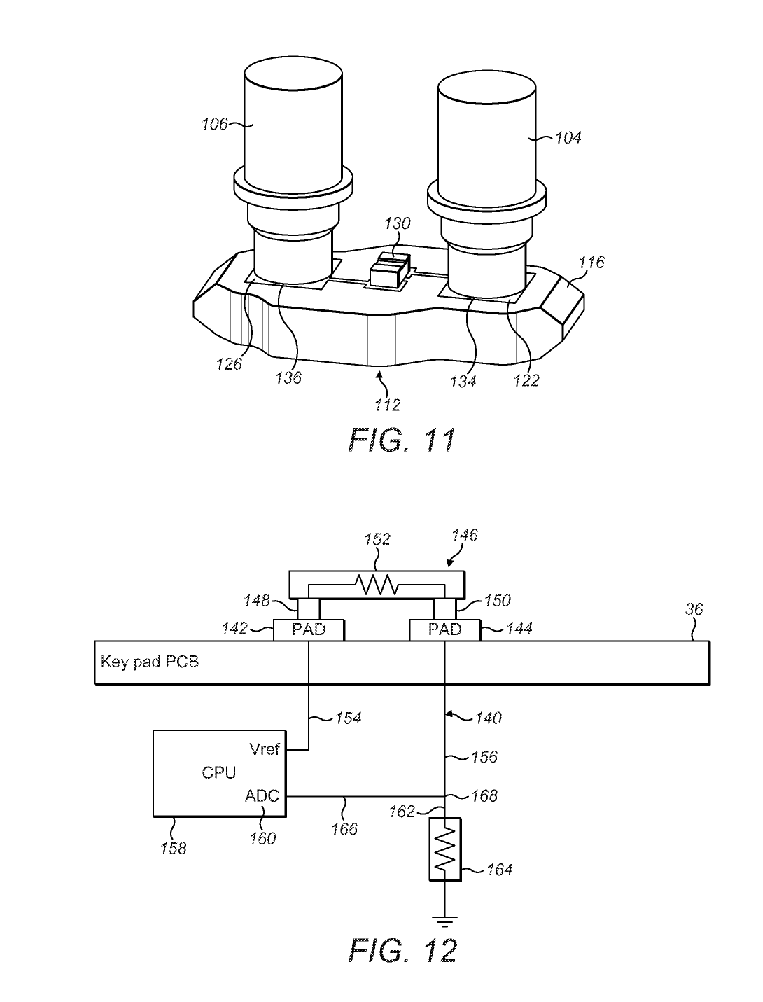

A third, alternative tamper detection mechanism is shown in FIG. 12. The third tamper detection mechanism can be used in a keypad device in place of the tamper detection mechanism described above with reference to FIGS. 1 to 7.

The third tamper detection mechanism has an electrical pathway 140. The electrical pathway includes first and second spaced conductive pads 142, 144. The electrical pathway also includes a connector 146 comprising two spring-loaded pins 148, 150 connected by a resistor 152. The electrical pathway 140 includes a first track 154 leading to the first conductive pad 142 and a second track 156 leading from the second conductive pad 144.

The third tamper detection mechanism also includes circuitry that provides an indication of the resistance of the electrical pathway 140. The circuitry comprises a processor 158, an analogue-to-digital converter (ADC) 160, a third track 162 leading via a resistor 164 to Earth, and a fourth track 166 leading to the ADC 160. As shown in FIG. 12, the second track 156, the third track 162 and the fourth track 166 meet at a junction 168.

The arrangement of the electrical pathway and the circuitry forms a voltage divider.

The third tamper detection mechanism may be incorporated into the PIN entry device shown in FIG. 1. In this case, the first and second conductive pads 142, 144 are located on the front surface of the main printed circuit board 36 and face towards the front casing half 26. The connector 146 is located between the front casing half 26 and the main printed circuit board 36. If the front casing half 26 is moved away from the main printed circuit board 36, the connector 146 moves away from the two conductive pads 142, 144.

In use, the processor 158 provides a reference voltage to the first track 154, the analogue input at the ADC 160 is representative of the voltage across the resistor 164. If the connector 146 is separated from the conductive pads 142, 144, the electrical pathway 140 is opened and the input at the ADC 160 is zero. Alternatively, if the connector 146 is removed after first shorting together the conductive pads 142, 144, the resistance provided by the resistor 152 will be removed from the electrical pathway 140 and as a result the voltage across the resistor 164, as measured by the processor 158 (after conversion to a digital signal by the ADC 160), will be altered. In either case, the processor identifies the change in input as a tamper event.

Further description of some example embodiments:

### Embodiment 1

A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; wherein the connector comprises a resistor of predefined resistance which in said closed conductive configuration is included in the electrical pathway; and wherein the mechanism is such that the circuitry can distinguish, on the basis of the resistance of the electrical pathway, between said connection of said electrical contacts by the connector and shorting between the two electrical contacts.

### Embodiment 2

A keypad device according to Embodiment 1, wherein when the electrical pathway is in the closed conductive configuration, the resistor contributes to the electrical pathway a predetermined percentage of the total resistance of the electrical pathway.

### Embodiment 3

A keypad device according to Embodiment 1 or Embodiment 2, wherein the predefined resistance is at least 1 k ohm.

### Embodiment 4

A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; the connector comprising a resistor of predefined resistance which in said closed conductive configuration is included in the electrical pathway; wherein when the electrical pathway is in the closed conductive configuration the resistor contributes to the electrical pathway a predetermined percentage of the total resistance of the electrical pathway.

### Embodiment 5

A keypad device according to Embodiment 2 or Embodiment 4, wherein the predetermined percentage is at least 2%.

### Embodiment 6

A keypad device according to Embodiment 5, wherein the predetermined percentage is at least 5%.

### Embodiment 7

A keypad device according to Embodiment 6, wherein the predetermined percentage is at least 10%.

### Embodiment 8

A keypad device according to any one of Embodiments 4 to 7, wherein the predefined resistance is at least 1 k ohm.

### Embodiment 9

A keypad device according to any one of Embodiments 2 and 4 to 8, wherein the circuitry is configured to allow detection of a percentage decrease of said total resistance of the electrical pathway equal to said predetermined percentage.

### Embodiment 10

A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the contacts to open the electrical pathway for the detection of tampering; the connector comprising a resistor which in said closed conductive configuration is included in the electrical pathway; the resistor having a resistance of at least 1 k ohm.

### Embodiment 11

A keypad device according to any one of Embodiments 3, 8 or 10, wherein the resistance is at least 2 k ohm.

### Embodiment 12

A keypad device according to Embodiment 11, wherein the resistance is at least 5 k ohm.

### Embodiment 13

A keypad device according to any preceding Embodiment, wherein the electrical pathway includes at least one further resistor.

### Embodiment 14

A keypad device according to any preceding Embodiment, wherein the electrical pathway includes a serpentine track.

### Embodiment 15

A keypad device according to any preceding Embodiment, wherein an attempt to form an electrical connection between the electrical contacts by a bridge would be detected by the detection circuitry at least either when the bridge connects the contacts in parallel with the connector, or when the bridge connects the contacts in place of the connector, regardless of the resistance of the bridge.

### Embodiment 16

A keypad device according to any preceding Embodiment, wherein the connector comprises two electrically conductive spring loaded pins, the resistor being connected between the spring loaded pins, the mechanism being configured so that in operation each spring-loaded pin contacts a respective one of the pair of electrical contacts.

### Embodiment 17

A keypad device according to Embodiment 16, wherein the mechanism is configured such that when the connector bridges the pair of electrical contacts to form said connection therebetween, the spring-loaded pins are compressed, said compression tending to maintain the pins in contact with the electrical contacts.

### Embodiment 18

A keypad device according to any one of Embodiments 1 to 15, wherein two electrically conductive spring loaded pins are mounted on the printed circuit board and wherein each spring loaded pin has a respective pin tip which forms a corresponding one of the electrical contacts.

### Embodiment 19

A keypad device according to Embodiment 18, wherein the mechanism is configured such that when the connector bridges the pair of electrical contacts to form said connection therebetween, the spring-loaded pins are compressed.

### Embodiment 20

A keypad device according to any preceding Embodiment, wherein the pair of electrical contacts is surrounded by an electrically conductive track that is connected to Earth.

### Embodiment 21

A keypad device according to any preceding Embodiment, wherein the electrical pathway is provided on the printed circuit board.

### Embodiment 22

A keypad device according to any preceding Embodiment, wherein the electrical contacts face the casing part.

### Embodiment 23

A keypad device according to any preceding Embodiment, wherein the printed circuit board has a surface facing the casing part and the electrical contacts are provided on said surface of the printed circuit board.

### Embodiment 24

A keypad device according to any preceding Embodiment, wherein the connector is located between the casing part and the printed circuit board.

### Embodiment 25

A keypad device according to any preceding Embodiment, wherein the printed circuit board bears a processor configured to encrypt the electrical signals.

### Embodiment 26

A keypad device according to any preceding Embodiment, wherein a resilient key mat is provided between the casing part and the printed circuit board.

### Embodiment 27

A keypad device according to Embodiment 26, wherein the connector is housed in a recess in the key mat, the key mat being attached to the casing part so that movement of the casing part away from the printed circuit board moves the connector away from the printed circuit board.

### Embodiment 28

A keypad device according to any preceding Embodiment, wherein the casing part is provided with holes for receiving key tops.

### Embodiment 29

A keypad device according to any preceding Embodiment, wherein the casing part forms a first side of the keypad device, the keypad device also comprising a further casing part which forms a second side of the keypad device, the first side being opposite to the second side.

### Embodiment 30

A keypad device according to Embodiment 29, wherein the casing part and the further casing part fit together to enclose the printed circuit board and the tamper detection mechanism.

What is claimed is:

1. A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; wherein the connector comprises a resistor of predefined resistance which in said closed conductive configuration is included in the electrical pathway; and wherein the mechanism is such that the circuitry can distinguish, on the basis of the resistance of the electrical pathway, between said connection of said electrical contacts by the connector and shorting between the two electrical contacts.

2. A keypad device according to claim 1, wherein the electrical contacts face the casing part.

3. A keypad device according to claim 1, wherein the printed circuit board has a surface facing the casing part and the electrical contacts are provided on said surface of the printed circuit board.

4. A keypad device according to claim 1, wherein the connector is located between the casing part and the printed circuit board.

5. A keypad device according to claim 1, wherein a resilient key mat is provided between the casing part and the printed circuit board.

6. A keypad device according to claim 5, wherein the connector is housed in a recess in the key mat, the key mat being attached to the casing part so that movement of the casing part away from the printed circuit board moves the connector away from the printed circuit board.

7. A keypad device according to claim 1, wherein an attempt to form an electrical connection between the electrical contacts by a bridge would be detected by the detection circuitry at least either when the bridge connects the contacts in parallel with the connector, or when the bridge connects the contacts in place of the connector, regardless of the resistance of the bridge.

8. A keypad device according to claim 1, wherein the connector comprises two electrically conductive spring loaded pins, the resistor being connected between the spring loaded pins, the mechanism being configured so that in operation each spring-loaded pin contacts a respective one of the pair of electrical contacts.

9. A keypad device according to claim 1, wherein two electrically conductive spring loaded pins are mounted on the printed circuit board and wherein each spring loaded pin has a respective pin tip which forms a corresponding one of the electrical contacts.

10. A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the electrical contacts to open the electrical pathway for the detection of tampering; the connector comprising a resistor of predefined resistance which in said closed conductive configuration is included in the electrical pathway; wherein when the electrical pathway is in the closed conductive configuration the resistor contributes to the electrical pathway a predetermined percentage of the total resistance of the electrical pathway.

11. A keypad device according to claim 10, wherein the predetermined percentage is at least 2%.

12. A keypad device according to claim 11, wherein the predetermined percentage is at least 5%.

13. A keypad device according to claim 12, wherein the predetermined percentage is at least 10%.

14. A keypad device according to claim 10, wherein the circuitry is configured to allow detection of a percentage decrease of said total resistance of the electrical pathway equal to said predetermined percentage.

15. A keypad device according to claim 10, wherein the electrical contacts face the casing part.

16. A keypad device according to claim 10, wherein the printed circuit board has a surface facing the casing part and the electrical contacts are provided on said surface of the printed circuit board.

17. A keypad device according to claim 10, wherein the connector is located between the casing part and the printed circuit board.

18. A keypad device comprising: a printed circuit board, a casing part and a tamper detection mechanism; the casing part holding keys operable by a user to enter information; the printed circuit board being configured to generate electrical signals representative of said entered information; the tamper detection mechanism comprising: an electrical pathway having a closed conductive configuration and being openable to prevent electrical conduction along the electrical pathway; and circuitry connected to the electrical pathway and configured to detect a change in the resistance of the electrical pathway; the electrical pathway including a pair of electrical contacts electrically isolated from one another; the electrical pathway also including a connector which in said closed conductive configuration of the electrical pathway bridges said electrical contacts to form an electrical connection therebetween, wherein movement of the casing part away from the printed circuit board causes the connector to move away from the contacts to open the electrical pathway for the detection of tampering; the connector comprising a resistor which in said closed conductive configuration is included in the electrical pathway; the resistor having a resistance of at least 1 k ohm.

19. A keypad device according to claim 18, wherein the resistance is at least 2 k ohm.

20. A keypad device according to claim 19, wherein the resistance is at least 5 k ohm.

21. A keypad device according to claim 18, wherein the electrical contacts face the casing part.

22. A keypad device according to claim 18, wherein the printed circuit board has a surface facing the casing part and the electrical contacts are provided on said surface of the printed circuit board.

23. A keypad device according to claim 18, wherein the connector is located between the casing part and the printed circuit board.
